(19) United States
(12) Patent Application Publication
(10) Pub. No.: US 2026/0162356 A1
(43) Pub. Date: Jun. 11, 2026

(54) VIEW INDEPENDENT HIERARCHICAL SORTING FOR SPLATTING OF 3D GAUSSIANS

(71) Applicant: HUAWEI TECHNOLOGIES CO., LTD., Shenzhen (CN)

(72) Inventors: Mohamed Ibrahim Hafez Ibrahim, Milton (CA); Shufang Lu, Markham (CA); Keyi Liu, Markham (CA); Yang Liu, Toronto (CA)

(73) Assignee: HUAWEI TECHNOLOGIES CO., LTD., Shenzhen (CN)

(21) Appl. No.: 18/970,370

(22) Filed: Dec. 5, 2024

(51) Int. Cl. G06T 15/20

(52) U.S. Cl. CPC G06T 15/20

(57) ABSTRACT

A method at a computing device for splatting of objects, the method including preforming a pre-processing on a scene, the pre-processing comprising: placing the objects into a Bounding Volume Hierarchy by creating nodes and leaf nodes; and sorting the objects in each leaf node with respect to a center of the leaf node, thereby creating sorted objects for each leaf node. The method further including traversing the Bounding Volume Hierarchy during rendering, the traversing comprising: finding an order of the nodes and leaf nodes based on a viewpoint; and fetching the sorted objects in each leaf node. The method further including creating a scene representation based on the fetching.

### FIELD OF THE DISCLOSURE

The present disclosure relates to rendering of images, and in particular relates to 3D reconstruction and novel view synthesis.

### BACKGROUND

The background description includes information that may be useful in understanding the present inventive subject matter. It is not an admission that any of the information provided herein is prior art or applicant admitted prior art, or relevant to the presently claimed inventive subject matter, or that any publication specifically or implicitly referenced is prior art or applicant admitted prior art. Novel view synthesis is a technique in computer vision and graphics that generates new images of a scene from viewpoints that were not part of the original dataset. This involves creating realistic images from different angles, lighting conditions, or perspectives based on a limited set of input images. The goal is to produce visually coherent and accurate representations of the scene as if they were captured from those new viewpoints.

Applications for novel view synthesis include: scene reconstruction, which involves reconstructing three dimensional (3D)/four dimensional (4D) scenes from a set of input images enabling operations such as scene navigation; baked in global illumination, which allows for global illumination effects such as ambient occlusion, indirect light and shadows being visible; spatial intelligence, which can be used to enable agents to observe the 3D world, understand it and act upon this understanding to perform various tasks; high quality materials, which may be captured from input images at high quality much better than rendered materials; and inverse rendering, which can be used to extract 3D meshes, Bidirectional Reflectance Distribution Function (BRDF), ambient occlusion and depth maps; Among other options.

Various techniques exist for 3D reconstruction and novel view synthesis. These include 3D Gaussian Splatting and Depth Peeling. 3D Gaussian splatting is a method used in the context of 3D reconstruction and novel view synthesis. It involves representing a 3D scene using a set of Gaussian ellipsoids, which are mathematical shapes that can efficiently model the scene's geometry and appearance.

Depth peeling is a technique used in computer graphics to achieve order-independent transparency, which is crucial for rendering scenes with multiple overlapping transparent objects. The method works by rendering the scene multiple times, each time peeling away a layer of depth to correctly composite the transparent fragments. For given view, the object is decomposed into layers such that the layers are ordered front-to-back with respect to the viewpoint.

### SUMMARY

According to at least a first aspect of the present disclosure, there is provided a method at a computing device for splatting of objects, the method comprising preforming a pre-processing on a scene, the pre-processing comprising placing the objects into a Bounding Volume Hierarchy by creating nodes and leaf nodes; and sorting the objects in each leaf node with respect to a center of the leaf node, thereby creating sorted objects for each leaf node; traversing the Bounding Volume Hierarchy during rendering, the traversing comprising finding an order of the nodes and leaf nodes based on a viewpoint; and fetching the sorted objects in each leaf node; and creating a scene representation based on the fetching.

In a first implementation of the first aspect, the objects are Three Dimensional (3D) Gaussians.

In a second implementation of the first aspect, the placing comprises setting a parameter for the maximum number of objects that should be present in each leaf node, wherein, when the maximum number of objects for a first leaf node exceeds the parameter, an additional node is created.

In a third implementation of the first aspect, the Bounding Volume Hierarchy uses a data structure comprising at least one of an octree and a k-dimensional tree.

In a fourth implementation of the first aspect, the fetching further comprises: dividing each leaf node into a positive space and a negative space based on the viewpoint; fetching objects from those most distant from the center of the leaf node to those closest to the center of the leaf node for the objects in the positive space; and fetching objects from those closest to the center of the leaf node to those most distant from the center of the leaf node for objects in the negative.

In a fifth implementation of the first aspect, the method further comprises, prior to the traversing: computing properties per object; and projecting each object to a two dimensional space; and after the traversing: blending all visible objects based on depth order.

In a sixth implementation of the first aspect, the sorting comprises: sorting the objects based on a distance from the mean of the object to the center of the leaf node.

In a seventh implementation of the first aspect, the method further comprises choosing a bounding box size for each leaf such that ∥g′∥² ∝d, where g′ is a vector from the center of each leaf node to the mean of the object; d is a dot product of a view direction with a g vector; and the g vector is a vector from the view direction to the mean of the object.

In an eighth implementation of the first aspect, the pre-processing and traversing are further performed during training.

In a second aspect, a computing device comprising a memory; and a processor is provided. The computing device is configured to: preform a pre-processing on a scene by: placing the objects into a Bounding Volume Hierarchy by creating nodes and leaf nodes; and sorting the objects in each leaf node with respect to a center of the leaf node, thereby creating sorted objects for each leaf node. The computing device is configured to traverse the Bounding Volume Hierarchy during rendering by: finding an order of the nodes and leaf nodes based on a viewpoint; and fetching the sorted objects in each leaf node. The computing device is configured to create a scene representation based on the fetching.

In a first implementation of the second aspect, the objects are Three Dimensional (3D) Gaussians.

In a second implementation of the second aspect, the placing comprises setting a parameter for the maximum number of objects that should be present in each leaf node, wherein, when the maximum number of objects for a first leaf node exceeds the parameter, an additional node is created.

In a third implementation of the second aspect, the Bounding Volume Hierarchy uses a data structure comprising at least one of an octree and a k-dimensional tree.

In a fourth implementation of the second aspect, the computing device is configured to perform the fetching by: dividing each leaf node into a positive space and a negative space based on the viewpoint; fetching objects from those most distant from the center of the leaf node to those closest to the center of the leaf node for the objects in the positive space; and fetching objects from those closest to the center of the leaf node to those most distant from the center of the leaf node for objects in the negative space.

In a fifth implementation of the second aspect, the computing device is further configured to render by: prior to the traversing: computing properties per object; and projecting each object to a two dimensional space; and after the traversing: blending all visible objects based on depth order.

In a sixth implementation of the second aspect, the computing device is configured to sorting the objects based on a distance from the mean of the object to the center of the leaf node.

In a seventh implementation of the second aspect, the computing device is further configured to choose a bounding box size for each leaf such that ∥g′∥²∝d, where g′ is a vector from the center of each leaf node to the mean of the object; d is a dot product of a view direction with a g vector; and the g vector is a vector from the view direction to the mean of the object.

In an eighth implementation of the second aspect, the computing device is configured to perform the pre-processing and traversing during training.

In a third aspect, a non-transitory computer readable medium for storing instruction code is provided. The instruction code, when executed by a processor of a computing device, cause the computing device to: preform a pre-processing on a scene by: placing the objects into a Bounding Volume Hierarchy by creating nodes and leaf nodes; and sorting the objects in each leaf node with respect to a center of the leaf node, thereby creating sorted objects for each leaf node; traverse the Bounding Volume Hierarchy during rendering by: finding an order of the nodes and leaf nodes based on a viewpoint; and fetching the sorted objects in each leaf node; and create a scene representation based on the fetching.

In a first implementation of the third aspect, the objects are Three Dimensional (3D) Gaussians.

### BRIEF DESCRIPTION OF THE DRAWINGS

The present disclosure will be better understood having regard to the drawings in which:

FIG. 1A is a block diagram showing depth peeling at a first iteration.

FIG. 1B is a block diagram showing depth peeling at a second iteration.

FIG. 1C is a block diagram showing depth peeling at a third iteration.

FIG. 1D is a block diagram showing depth peeling at a fourth iteration.

FIG. 2 is a block diagram showing a rendering pipeline.

FIG. 3 is a block diagram showing a rendering pipeline with improved sorting.

FIG. 4 is a block diagram showing a bounding volume hierarchy tree.

FIG. 5 is a block diagram showing a depth sort from a first viewpoint.

FIG. 6 is a block diagram showing a depth sort from a second viewpoint.

FIG. 7 is a block diagram showing a radial sort.

FIG. 8 is a block diagram illustrating variables used for determining sorting order.

FIG. 9 is a block diagram showing a line of vision passing through a Gaussian mean and a node center.

FIG. 10 is a block diagram showing a plurality of leaf nodes.

FIG. 11 is a process diagram showing a process for improved rendering using radial sorts within each leaf node.

FIG. 12 is a block diagram a sphere having arc lines in a direction of a line of vision.

FIG. 13 is a block diagram showing rendering of 3D Gaussians based on whether they are in a positive or negative plane.

FIG. 14 is a process diagram showing a process for rendering using a line of vision to define positive and negative planes for leaf nodes.

FIG. 15 is a block diagram showing an example simplified computing device capable of being used with the embodiments of the present disclosure.

### DETAILED DESCRIPTION OF THE DRAWINGS

In one embodiment, the present disclosure is directed improved rendering through the creation of view independent hierarchical sorting for splatting of 3D Gaussians.

In some embodiments, rendering is improved using pre-processing which radially sorts 3D Gaussians within leaf nodes and further places the leaf nodes in a Bounding Volume Hierarch.

In some embodiments, rendering is further improved by providing 3D Gaussians that were radially sorted based on whether they are in a positive or negative plane from a line of vision.

Therefore, the embodiments described herein improve a rendering pipeline for 3D Gaussian rendering by improving rendering speeds.

### 3D Gaussian Splatting and Depth Peeling

3D Gaussian splatting (3DGS) is a method used in the context of 3D reconstruction and novel view synthesis and provides a rendering technique that projects and blends 3D Gaussian representations of a 3D scene to generate an image. Thus it involves representing a 3D scene using a set of Gaussian ellipsoids, which are mathematical shapes that can efficiently model the scene's geometry and appearance.

3D Gaussian splatting was, for example, described by Kerbl et al, “3D Gaussian Splatting for Real-Time Radiance Field Rendering”, arXiv: 2308.04079, August 2023, the contents of which are incorporated herein by reference. 3D Gaussian Splatting methods represent the 3D world with a set of 3D points, which may include hundreds of thousands or millions of such points. Each point is a 3D Gaussian with its own unique parameters that are fitted per scene such that renders of this scene match closely to the known dataset images. Each 3D Gaussian is parameterized by: a mean u interpretable as location x, y, z; a covariance matrix Σ; an opacity value σ(α) (a sigmoid function is applied to map the parameter to the [0, 1] interval), and color parameters, either 3 values for (R, G, B) or spherical harmonics (SH) coefficients.

This method contrasts with neural implicit representations including Neural Radiance Fields (NeRFs), as described in Mildenhall et al., “NeRF: Representing Scenes as Neural Radiance Fields for View Synthesis”, arXiv: 2003.08934, March 2020, the contents of which are incorporated herein by reference, which use neural networks to encode the scene.

Compared to NeRFs, 3D Gaussian methods have the following advantages: There is no Multilayer Perceptron (MLP) to be inferenced height times width times number of pixels (H·W·P) times for a single image, two dimensional (2D) Gaussians are blended onto an image directly. Additionally, there is no ambiguity in which 3D point to evaluate along the ray, no need to choose a ray sampling strategy (a set of 3D points overlapping the ray of each pixel (N) is discrete and fixed after optimization). Finally, a pre-processing sorting stage is done once per frame, on a Graphics Processing Unit (GPU), using a custom implementation of differentiable Compute Unified Device Architecture (CUDA) kernels. As used herein, a GPU is the hardware used to execute instructions of a computer software usually intended for graphics applications or highly parallel code.

Depth peeling is a technique used in computer graphics to achieve order-independent transparency, which is crucial for rendering scenes with multiple overlapping transparent objects. The method works by rendering the scene multiple times, each time peeling away a layer of depth to correctly composite the transparent fragments. This approach ensures accurate visualization of complex images, even when objects intersect or overlap.

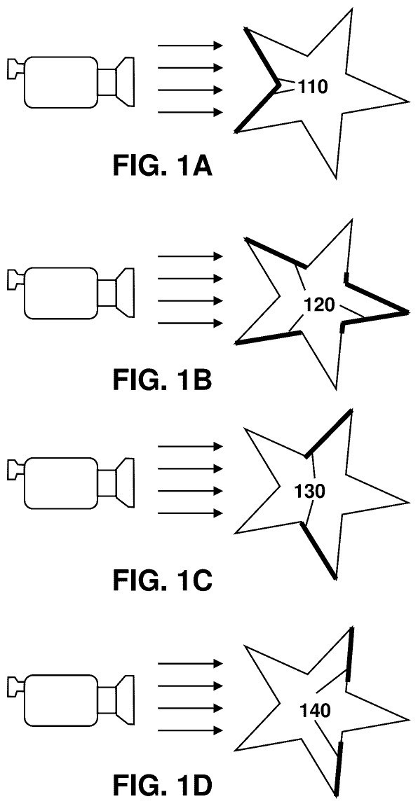

A visual overview of the depth peeling method is shown in FIGS. 1A, 1B, 1C and 1D. In particular, as seen in FIG. 1A, a first depth layer 110 provides the initial layer encountered from a viewpoint. Once layer 110 is peeled away, layers 120 become visible, as shown in FIG. 1B. Once layers 120 are peeled away, layers 130 become visible, as shown in FIG. 1C. Once layers 130 are peeled away, layers 140 become visible, as shown in FIG. 1D.

Ever since the original 3D Gaussian Splatting method was introduced, many works in the field have come out to address different parts of its pipeline. This includes improving the final rendered image quality, reducing the training time, increasing the rendering speed and reducing the memory footprint.

Examples of such works include Kerbl et al., supra, which introduces a hierarchical framework for representing 3D data using Gaussian distributions, aimed at enhancing real-time rendering capabilities. The method is designed to efficiently handle very large datasets, making it suitable for applications requiring quick and interactive visualizations. By leveraging a hierarchical structure, the approach optimizes both memory usage and computational performance. Ren et al., “Octree-GS: Towards Consistent Real-time Rendering with LOD-Structured 3D Gaussians”, arXiv: 2403.17898, March 2024, the contents of which are incorporated herein by reference, introduces a method for real-time rendering using Level-of-Detail (LOD) techniques. This approach dynamically selects the appropriate level of detail for each part of a scene, ensuring consistent rendering performance and high-fidelity results. By leveraging an LOD-structured 3D Gaussian representation, the method efficiently handles large scenes with varying levels of detail.

Both of these methods introduce hierarchical traversal/processing of 3D Gaussians, but they do not address view independent sorting.

One work that addresses sorting is Joo Chan Lee et al., “Compact 3d gaussian representation for radiance field”, Proceedings of the IEEE/CVF Conference on Computer Vision and Pattern Recognition, pp. 21719-21728, 2024, the contents of which are incorporated herein by reference. Lee introduces hardware supported optimizations to 3D Gaussian Splatting Rendering. Amongst these optimizations, is a hierarchical sorting method that reduces the overhead associated with Gaussian sorting. The key idea in this publication is to initially perform approximate sorting of all Gaussians, ensuring that the Gaussians in Group i have lower depth values than those in Group i+1, while the Gaussians within each group are not strictly ordered. Subsequently, we precisely sort each Gaussian group at the time it is needed for rasterization runtime.

In accordance with the embodiments of the present disclosure, a hierarchical traversal of 3D Gaussians is provided, but with view independent sorting along with a 3D Gaussian fetching method that does not require per-view sorting of individual 3D Gaussians. In some embodiments, hierarchical sorting is also targeted, but since the sorting of the present disclosure is view independent, the techniques described below do not require per-view sorting of individual 3D Gaussians.

### 3D Gaussian Rendering

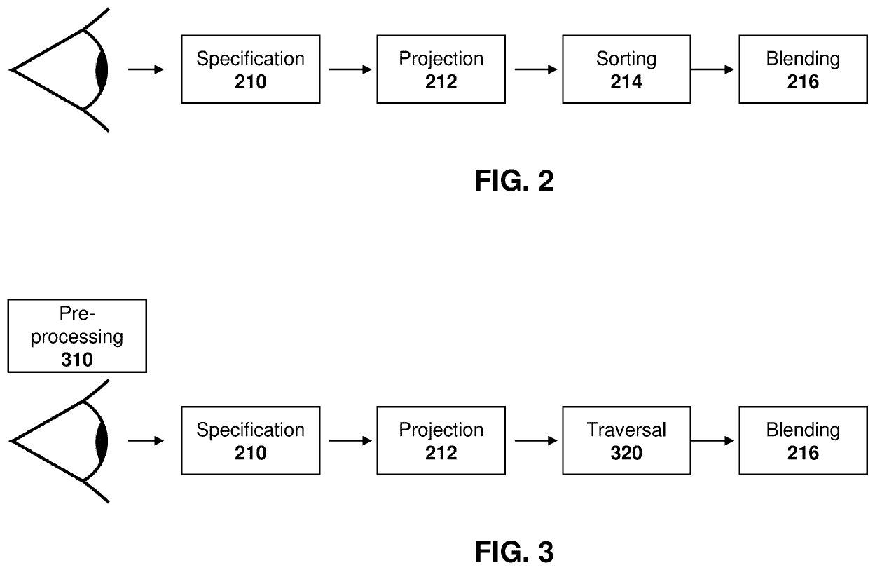

Reference is now made to FIG. 2, which shows a 3DGS rendering pipeline. In particular, rendering of 3D gaussians is composed of four main elements, shown with specification block 210, projection block 212, sorting block 214 and blend block 216.

At specification block 210, the pipeline computes properties per Gaussian. For example, this may be the color from Spherical Harmonics (SH), covariance 3D from rotation and scaling, among other factors. In addition, the pipeline culls Gaussians outside of the view frustrum.

At projection block 212, the pipeline projects 3D Gaussians to 2D, computes the 2D convolution layer (conv2d) from the 3D convolution layer (conv3d), and computes per Gaussian 2D bounding boxes.

At sorting block 214, the pipeline sorts all Gaussians by depth. For a tile-based approach, this also includes associating tile identifier (ID) for each Gaussian, instantiating new Gaussian copies when shared across tiles, sorting by ID and depth, and then fetching Gaussians per tile.

At blending block 216, for each pixel, the pipeline blends all its own visible Gaussians according to the depth order.

The steps at blocks 210, 212, 214 and 216 are executed each time the view is changed during rendering.

The present disclosure focuses on the sorting step at block 214, and its implications on the whole 3DGS rendering pipeline. In particular, the sorting step is a processing bottleneck for compute bound platforms that have the GPU compute pipeline busy processing other tasks for the underlying application. It is also a bottleneck for platforms for which the time taken for sorting is linearly proportional. For example, this may be the case with Ascend 910B Neural Processing Unit (NPU), and X86 Central Processing Units (CPUs) as shown in Table 1.

TABLE 1
Sorting performance for different number
of samples on different platforms

| | X86 CPU | CUDA GPU | ARM Aarch64 | ASCEND NPU |
|---|---|---|---|---|
| # Samples | (ms) | 2080Ti(ms) | CPU (ms) | 910B (ms) |
| 10,000 | 1.396 | 0.609 | 0.841 | 0.036 |
| 100,000 | 18.648 | 0.1 | 22.557 | 0.263 |
| 1,000,000 | 226.496 | 0.463 | 126.909 | 1.348 |
| 10,000,000 | 2470.359 | 2.776 | 1412.048 | 13.099 |

From Table 1, the sorting step consumes about a tenth of the time taken for the whole 3DGS pipeline. Therefore, reducing the time taken to sort could result in high performance gains for the 3DGS rendering pipeline. In particular, reducing the time for the sorting step may be useful in reducing the time taken for the rendering of 3DGS as a whole for large scenes or for compute bound platforms.

Therefore, in accordance with embodiments of the present disclosure a hierarchical, view independent sorting method and system are provided that: i) respect visibility order and ii) can be implemented in a two-step methodology composed of a pre-processing step and an online (runs during rendering) step.

The two-step methodology can be broken down to a ‘pre-processing’ step that is computed for the individual 3D Gaussians, and a ‘traversal’ step that is treated as a Bounding Volume Hierarchy (BVH) traversal for the leaf nodes that can be easily implemented in rasterization and/or ray tracing pipelines. As used herein, a BVH is a hierarchical data structure usually used to spatially sub-divide a 3D scene and enclose its components in the nodes of the data structure for logarithmic traversal of the 3D scene.

The embodiments herein therefore transform online (per view) sorting to a pre-processing sorting step and a BVH traversal step (per view), significantly reducing the time required for sorting 3D Gaussians.

The 3DGS rendering pipeline shown in FIG. 2 is therefore transformed to the pipeline shown in FIG. 3. In the example of FIG. 3, specification block 210, projection block 212 and blending block 216 may be similar to those presented in FIG. 2.

However, in this case a preprocessing block 310 is provided prior to the rendering, and a traversal block 320 replaces the sorting block 214 of FIG. 2. Each is described below.

The first aspect is the ‘pre-processing’ stage at block 310. This stage includes two elements: BVH build-up, and radial sorting.

### Bounding Volume Hierarchy Build-Up

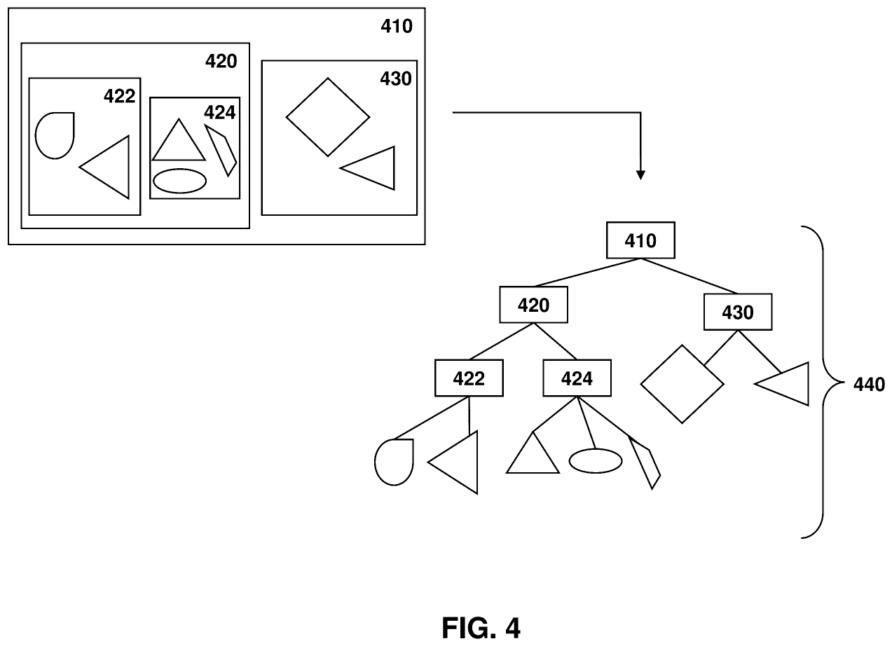

A BVH is a tree structure used to organize geometric objects for efficient collision detection and ray tracing. Each object is enclosed in a bounding volume, and these volumes are grouped hierarchically into larger bounding volumes. This structure allows for traversal of the scene, significantly improving performance in graphics and simulation applications. An example of a BVH is shown with regard to FIG. 4.

In the example of FIG. 4, object 410 has a bounding volume enclosing object 420 and object 430. Similarly, object 420 has a bounding volume enclosing object 422 and object 424.

Object 422, object 424 and object 430 include geometric objects therein. Such geometric objects can be placed into a tree structure 440 with each object being a node.

The number of objects, including geometric objects, within a particular object can be controlled by a user defined parameter. Specifically, given a set of 3D Gaussians, each 3D Gaussian can be placed into a BVH with a user defined parameter ‘ppl’ denoting the maximum number of 3D Gaussians that should be present in a leaf node. If a node has more Gaussians than ppl, the node may be broken down further into smaller nodes until each node has a number of Gaussians that is ≤ppl.

### Radial Sort

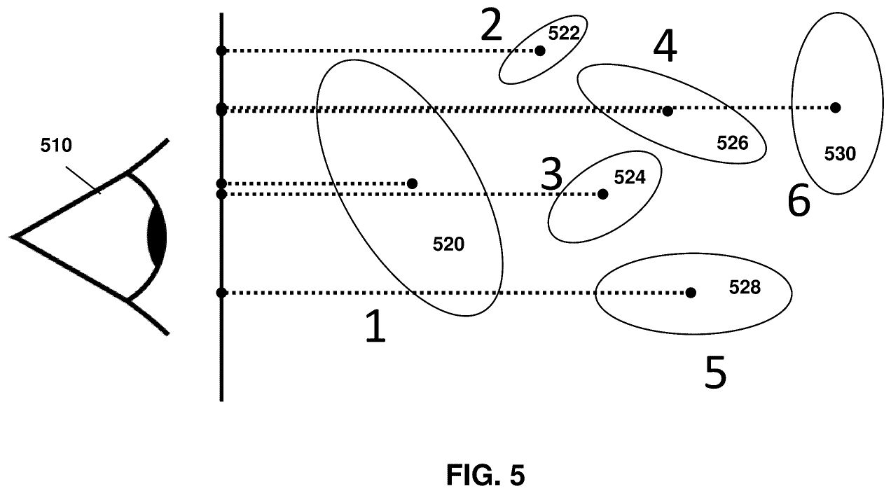

A second part of pre-processing block 310 is to sort all the 3D Gaussians in a leaf node radially. In other words, the sort is with respect to the distance of the mean of the 3D Gaussian u to the center of the leaf node x. An example of a radial sort of a leaf node versus depth-based sorting is shown in FIGS. 5 to 7.

In particular, in the example of FIG. 5, a first view 510 sees various Gaussians in a particular order. Depth based sorting then sorts the Gaussians based on the depth away from the viewpoint. Specifically, Gaussian 520 is first, Gaussian 522 is deeper and is second. Gaussian 524 is deeper and is third. Gaussian 526 is the 4th Gaussian in terms of depth. Gaussians 528 and 530 are the 5th and 6th Gaussians in terms of depth.

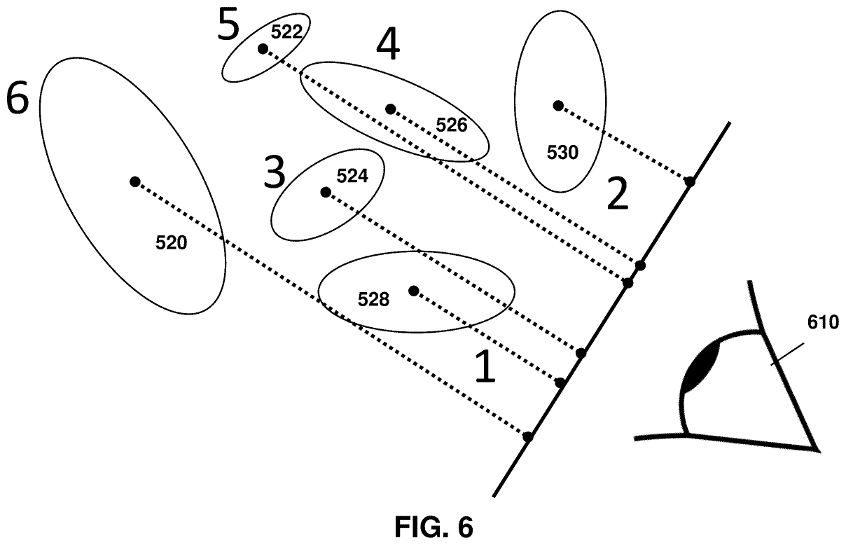

The sorting of FIG. 5 is however from the perspective of first view 510. If the view is changed to view 610, then the sorting changes. In particular, BVH needs to be reconstructed when the scene changes in rendering process partially due to resorting of Gaussians. Reference is now made to FIG. 6.

In the example of FIG. 6, second view 610 is used for the depth sort of the plurality of Gaussians. In this case, the depth sort would find Gaussian 528 first, Gaussian 530 second, Gaussian 524 third, Gaussian 526 fourth, Gaussian 522 fifth, and Gaussian 520 sixth.

Thus, from the depth based sorting examples of the FIGS. 5 and 6, Gaussians are sorted per view, which is an expensive operation on compute bound platforms.

The embodiments of the present disclosure allow for data to be pre-processed in a manner that generally avoids sorting per view. Specifically, while an exact sorting alternative is not possible, the present disclosure provides a good approximation that is not as computationally demanding.

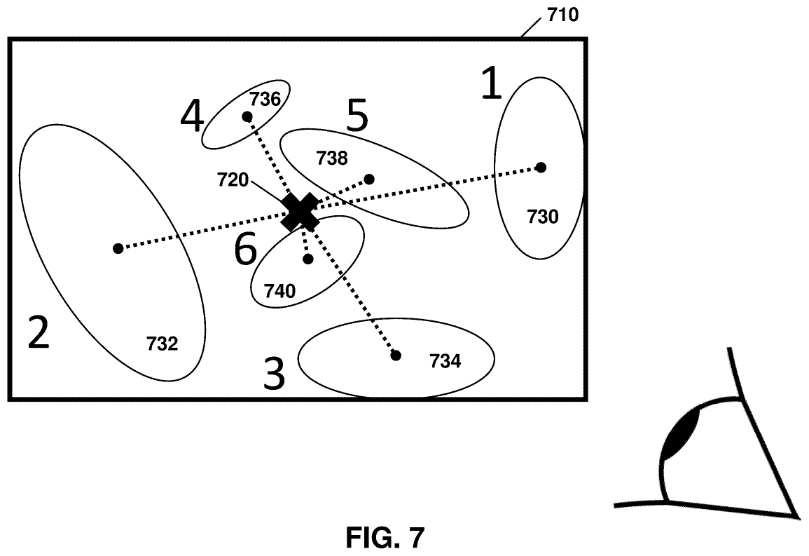

In particular, a view-independent or radial sort is shown with regard to FIG. 7. In this sort, the objects are sorted within a bounding box 710 from those Gaussians that are furthest out from a center 720 to those that a closest to the center 720.

Thus, in the example of FIG. 7, Gaussian 730 is the furthest from the center, and is first after sorting, Gaussian 732 is second, Gaussian 734 is third, Gaussian 736 is 4th, Gaussian 738 is fifth, and Gaussian 740 is 6th.

The sorting in FIG. 7 is view independent and can be done in a pre-processing stage. If further transforms a per-view sorting function to a per-view fetching (traversal) function.

As shown in FIGS. 5 to 7, the order resulting from the depth-based sort (the sorting method adapted in the original 3DGS paper that respects visibility) is very different from the radial sort. Since the 3DGS method optimizes the 3D Gaussians (location, color, orientation, etc. . . . ) assuming a depth-based sorting, if the sorting order deviates significantly from the depth-based sorting, the final image will be incorrect.

Therefore, in order for the radial sorting method to produce visually correct results, the resulting order of the 3D Gaussians from the radial sorting should be as close as possible to the depth-based sorting.

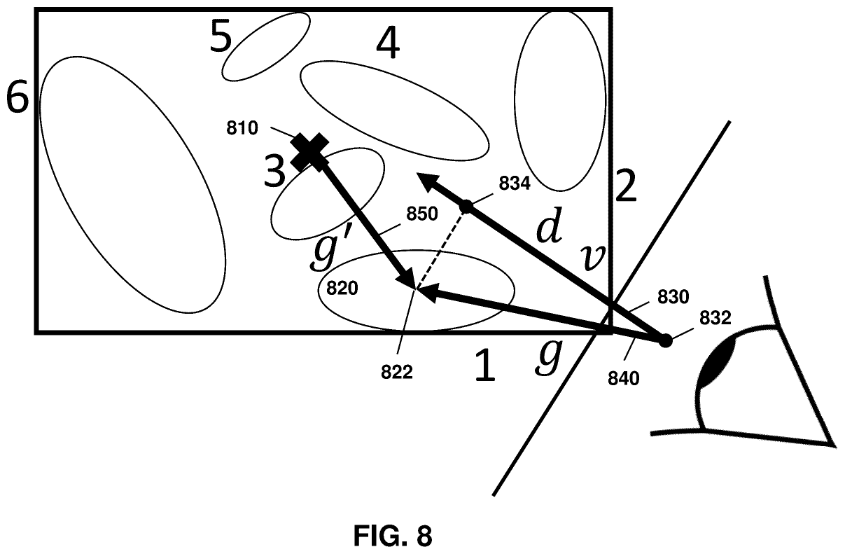

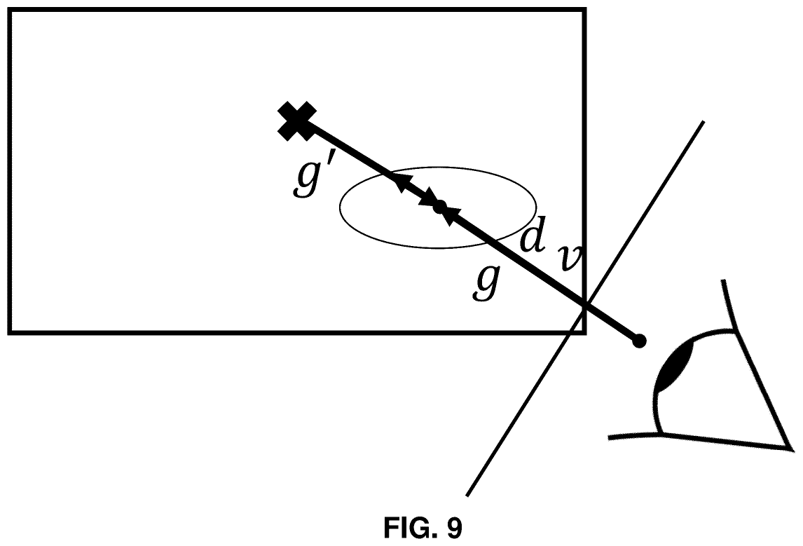

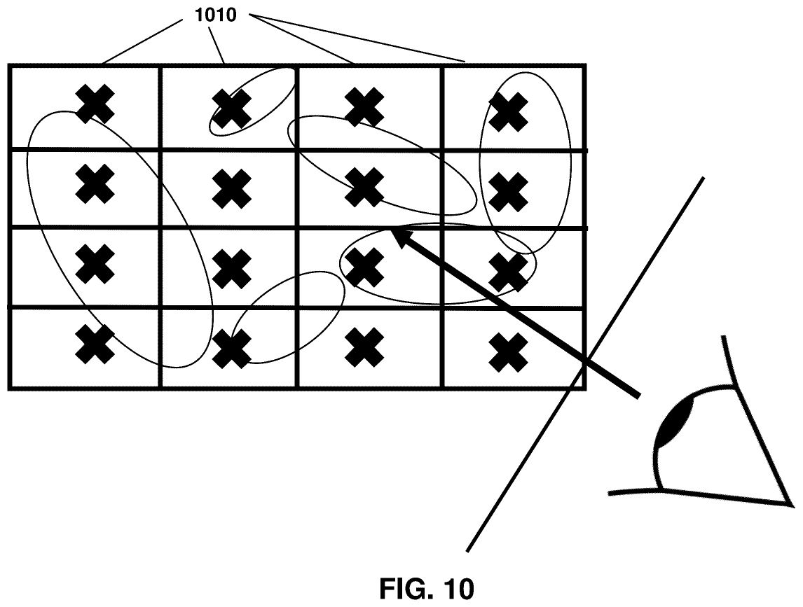

To that extent, a set of variables may be considered: v: view direction, μ: mean of a 3D Gaussian, x: center of a leaf node, g: vector from view point to μ, d=dot (v, g), and g′: vector from x to the μ. A variable visualization is provided with regards to FIG. 8.

In FIG. 8 the center of the leaf node 810 is x. Each Gaussian has a mean u, and in one example Gaussian 820 includes a mean 822. View direction v is shown with arrow 830. The g vector from the point of view to mean 822 is shown with arrow 840. The variable d is the dot product of the view direction and the g vector, and is thus on line 830 from point 832 to point 834. The g′: vector is shown with line 850 and goes from the center of the leaf node 810 to the mean 822.

Depth-based sorting sorts according to d, while radial sorting sorts according to ∥g′∥². Therefore, for the results of both sorting methods to be similar, we need to consider making ∥g′∥² ∝d.

Further, in a first condition, when g is parallel to v, d=∥g∥². In addition, in a second condition, if v passes through x, then g-g′=x. If both the first and second conditions can be met, then ∥g′∥² ∝d as shown in FIG. 9.

In particular, in the example of FIG. 9 the view passes through both the Gaussian mean and the centre of the leaf node. This then meets the conditions described above.

Therefore, the ‘smaller’ the leaf node bounding box, the higher the probability that g is parallel to v and that v passes through x. This is for example shown as a plurality of bounding boxes 1010 in FIG. 10.

Subdividing the scene into a BVH in which the leaf nodes contain the radially sorted Gaussians would control the level of approximation of the rendering. The smaller the leaf nodes, the closer the approximation per node to depth sort. For example, consider in the limit a leaf node that contains a single Gaussian.

Therefore a leaf node size may be optimized for computing efficiency.

On a per leaf level, the 3D Gaussians sorted in a manner that is proportional to depth-base sort.

Considering the leaves of the BVH, traversing the BVH given a view direction would result in depth sorted traversal of the nodes.

The sorting block 214 in FIG. 2 is therefore replaced with a ‘radial sort’ computed as a pre-processing step at block 310 of FIG. 3 for the individual 3D Gaussians and a ‘traversal’ at block 320 is treated as a BVH traversal for the leaf nodes that can be easily implemented in rasterization and/or ray tracing pipelines.

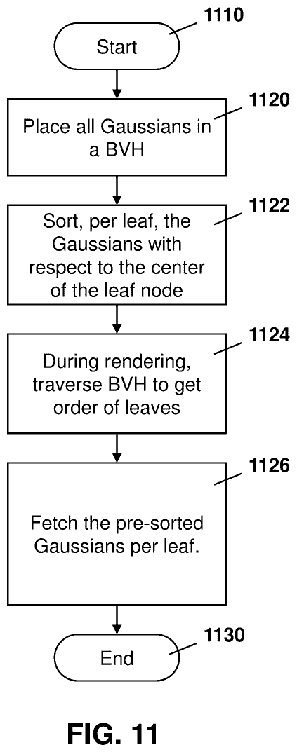

The above can therefore be summarised with regard to a FIG. 11. In the example of FIG. 11, the process starts at block 1110 and proceeds to block 1120 in which all Gaussians may be placed in a BVH, as shown in FIG. 4.

The process then proceeds to block 1122 in which a sorting, per leaf, is applied to all Gaussians with respect to the centre of the leaf node, as for example shown in FIG. 7.

In some cases, the process at blocks 1120 and 1122 may be done in reverse order—that is a radial sort on each node may be performed prior to the nodes being placed in a BVH.

The process at blocks 1120 and 1122 may be done at the pre-processing block 310. Subdividing the scene into a Bounding Volume Hierarchy data structure such as an octree, k-dimensional (KD) tree, etc., in which the leaf nodes contain the radially sorted Gaussians, may control the level of approximation of the rendering. Specifically, the smaller the leaf nodes, the closer the approximation per node is to a depth sort.

From block 1122, the process proceeds to block 1124 in which, depending on the viewpoint, the BVH may be traversed to get the order of the leaves. Specifically, traversing the BVH given a view direction would result in depth sorted traversal of the nodes.

The process then proceeds to block 1126 in which the pre-sorted Gaussians are fetched per leaf.

The process of blocks 1124 and 1126 may be done, for example, at traversal block 320 from FIG. 3.

From block 1126 the process proceeds to block 1130 and ends.

### 3DGS Fetching

A further aspect of some embodiments of the present disclosure is how the 3D Gaussians are fetched per leaf node once they are radially sorted.

As will be appreciated by those in the art having regard to the present disclosure, fetching 3D Gaussians according to radial sort, even for small leaf nodes, may return incorrect results. In some embodiments therefore, the methods and systems herein may be augmented with a depth-peeling based 3D Gaussian fetching method.

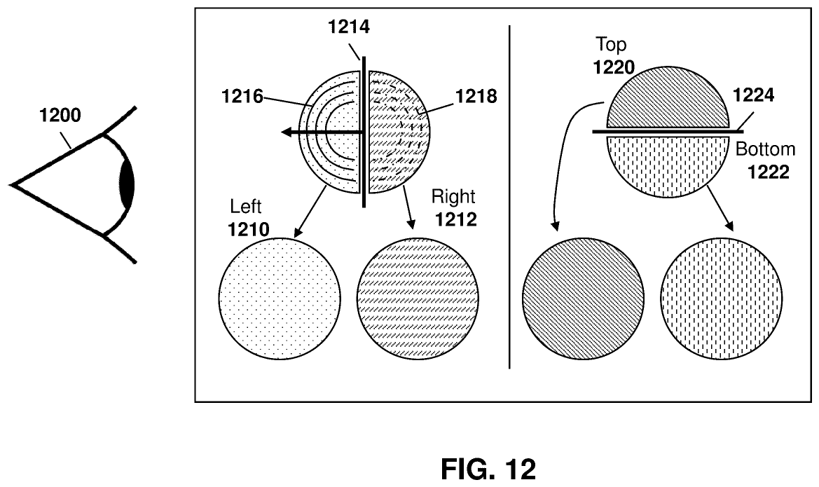

For example, FIG. 12 shows a sphere. Given a view direction 1200 and a spherical shape, if the spherical shape is considered to be semi-transparent, using a depth-peeling based method would result in correctly visualizing the scene. That is for the first globe, it may be split into left hemisphere 1210 and right hemisphere 1212 (by plane 1214) and each hemisphere may be discretize into a subset of arcs (visualized by arcs 1216 on the left hemisphere 1210 and arcs 1218 in the right hemisphere 1212). Arcs 1216 and 1218 may be visualized in a depth-peeling pattern. This would result in a correct visual result as long as the hemi-sphere is split with respect to the view direction 1200.

However, if the view changes by 90 degrees, the splitting plane 1224 would be between top hemisphere 1220 and bottom hemisphere 1222.

Since the 3D Gaussians inside a leaf node are sorted radially with respect to x, a similar fetching method to the one described above may be adopted. That is, for a given point of view, the node may be split by a plane whose normal vector n is pointing towards the viewpoint.

The 3D Gaussians may then be fetched inside the leaf node in the following order. If the Gaussian is in the positive half-space (above the plane) they are fetched in an ‘out to in’ order. Otherwise, the Gaussians are fetched in an ‘in to out’ order. Adopting such fetching results in an order that very similar to the depth-based sorting of FIGS. 5 and 6.

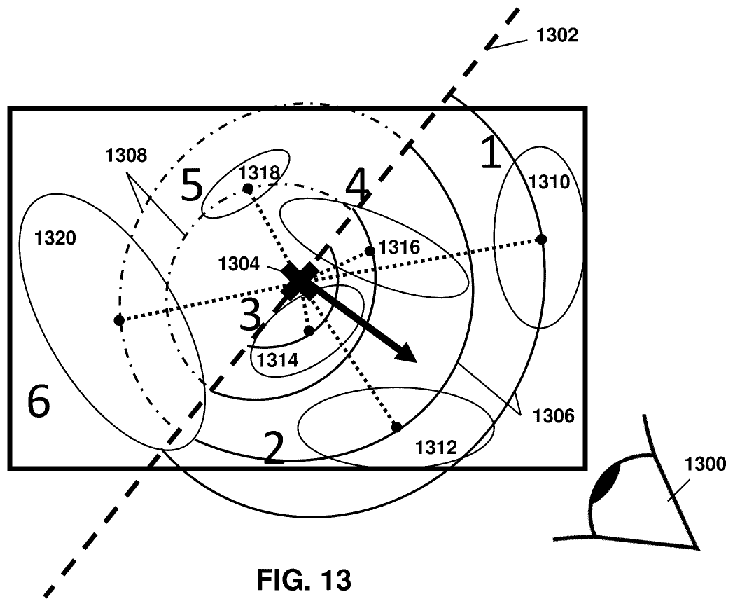

For example, reference is now made to FIG. 13, which shows the results of the fetching method based on whether the Gaussians are in the positive half space or the negative half space.

Thus, in the example of FIG. 13, a viewpoint 1300 has a view angle towards a node. A plane 1302 passes through the centre 1304 of the node, defining positive and negative spaces. In particular, arcs 1306 in the positive space and arcs 1308 in the negative space can be used in accordance with the embodiments of the present disclosure for ordering of the Gaussians.

Using such arcs and the preprocessed radial sort, Gaussians in the positive space are returned before Gaussians in the negative space. In this regard, Gaussian 1310 is returned first, Gaussian 1312 is returned second, Gaussian 1314 is returned third, and Gaussian 1316 is returned fourth. These Gaussians are in the positive space.

Gaussian 1318 and Gaussian 1320 are then returned fifth and sixth respectively, where Gaussians 1318 and 1320 are in the negative space.

Such Gaussians are therefore provided in an order that is similar to the order of the depth-based sort of FIG. 6.

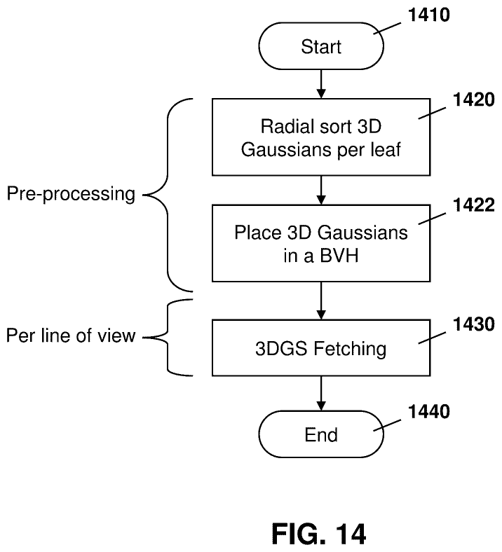

The process of FIGS. 12 and 13 can be summarized in FIG. 14.

In particular, the process of FIG. 14 starts at block 1410 and proceeds to block 1420 in which a radial sort of the 3D Gaussians per leaf may be performed. Thus, instead of sorting 3D Gaussians for every change of view, the 3D Gaussians are sorted once radially per leaf node in a pre-processing step. Such sorting is, for example, described with regard to FIG. 7.

The process then proceeds to block 1422 in which the 3D Gaussians can be placed in a BVH, as for example described with regard to FIG. 4.

The process at blocks 1420 and 1422 may be performed at the pre-processing block 310 of FIG. 3. This converts the process of sorting 3D Gaussians per view to the radial sort of block 1420 in pre-processing in addition to a BVH traversal which is a light weight operation.

After the pre-processing is completed and a per line of view rendering is needed, the process proceeds from block 1422 to block 1430 in which 3DGS fetching is performed. Such 3DGS fetching may, for example, define a positive and negative space for each leaf node and the 3D Gaussians may be returned first from the positive space in an outside-inwards direction, and second from the negative space in an inwards-outside direction. With such fetching method, combined with the process of blocks 1420 and 1422, sorting orders similar to depth-based methods may be achieved.

The process of block 1430 can, for example, be performed at the traversal block 320 from FIG. 3.

From block 1430, the process proceeds to block 1440 and ends.

### Results

The methods above were tested in practical situations, and resulted in significant rendering speedup for multiple datasets. In Table 2 below, for two scenes (first and second), a comparison was made between the methods herein (labeled bvh-radial) with the depth based method. Three modes (low, medium, high) were compared, each with a different number of leaves and value for ppl. In Tables 2A and 2B the pre-processing time, the sorting time and the rendering time taken for each approach is provided. Table 2B is a continuation of Table 2A.

TABLE 2A
Result Comparison (first part)

| | Sorting | # | # | Preprocessing | | |
|---|---|---|---|---|---|---|
| Scene | method | Gaussians | Leaves | Max_ppl | Time(s) | Quality |
| First | Depth | 97,855 | / | / | / | |
| scene | BVH- | | 40 | 10000 | 1.47 | low |
| | radial | | 398 | 1000 | 1.49 | medium |
| | | | 3869 | 100 | 1.53 | high |
| Second | Depth | 6,131,954 | / | / | / | |
| scene | BVH- | | 2567 | 10000 | 135.71 | low |
| | radial | | 24685 | 1000 | 142.76 | medium |
| | | | 239582 | 100 | 150.63 | high |

TABLE 2B
Result Comparison (second part)

| | | Sorting (CPU)(ms) | | | | | |
|---|---|---|---|---|---|---|---|
| | | | | | Push | Rendering | |
| | Sorting | Total | Sort | Construct | data | (FPS) | Speed |
| Scene | method | time | cpu | leafmap | GPU | CPU sort | up |
| First | Depth | 7.99 | 7.8 | / | 0.19 | 110 | / |
| scene | BVH- | 0.05 | 0.011 | 0.015 | 0.026 | 1570 | 14.27x |
| | radial | 0.095 | 0.025 | 0.045 | 0.025 | 1412 | 12.84x |
| | | 0.52 | 0.23 | 0.26 | 0.03 | 820 | 7.45x |
| Second | Depth | 781 | 768 | / | 13 | 1 | |
| scene | BVH- | 0.33 | 0.11 | 0.19 | 0.03 | 61 | 61x |
| | radial | 2.94 | 1.07 | 1.67 | 0.2 | 62 | 62x |
| | | 31.4 | 13.5 | 16.1 | 1.78 | 30 | 30x |

Based on Tables 2A and 2B, the implementations of the present disclosure resulted in a significant rendering speed up, without a reduction in quality, especially for high settings.

While the above embodiments show a method and system with regards to 3D Gaussians, the methods and systems could equally be applied to general mesh splatting. Thus, 3D Gaussians and other Gaussian surfaces could be generalized as “objects” herein.

Further the methods and systems herein could also be incorporated in training, such that instead of a depth-based sort, the sorting methods provided herein may be employed in the training pipeline. This may reduce the time needed for training and produce more accurate results during rendering.

The above therefore enhances the operation of a computing device for rendering images by improving rendering speed of such images.

### Example Hardware

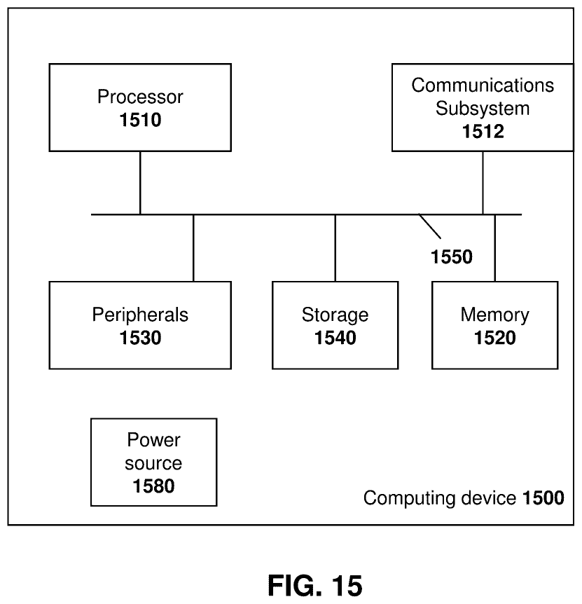

The above functionality may be implemented on any one or combination of computing devices. FIG. 15 is a block diagram of a computing device 1500 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, etc. The computing device 1500 may comprise a central processing unit (CPU) or processor 1510, communications subsystem 1512, memory 1520, a mass storage device 1540, and peripherals 1530.

Peripherals 1530 may comprise, amongst others one or more input/output devices, such as a speaker, microphone, mouse, touchscreen, keypad, keyboard, printer, display, network interfaces, and the like.

Communications between processor 1510, communications subsystem 1512, memory 1520, mass storage device 1540, and peripherals 1530 may occur through one or more buses 1550. The bus 1550 may be one or more of any type of several bus architectures including a memory bus or memory controller, a peripheral bus, video bus, or the like.

The processor 1510 may comprise any type of electronic data processor. The memory 1520 may comprise any type of system memory such as static random-access memory (SRAM), dynamic random access memory (DRAM), synchronous DRAM (SDRAM), read-only memory (ROM), a combination thereof, or the like. In an embodiment, the memory 1520 may include ROM for use at boot-up, and DRAM for program and data storage for use while executing programs.

The mass storage device 1540 may comprise any type of storage device configured to store data, programs, and other information and to make the data, programs, and other information accessible via the bus. The mass storage device 1540 may comprise, for example, one or more of a solid-state drive, hard disk drive, a magnetic disk drive, an optical disk drive, or the like.

In embodiments, a processor 1510 may execute instruction code stored in a non-transitory computer readable medium such as memory 1520 or mass storage device 1540 to perform the methods described herein.

The computing device 1500 may also include a communications subsystem 1512, which may include one or more network interfaces, which may comprise wired links, such as an Ethernet cable or the like, and/or wireless links to access nodes or different networks. The communications subsystem 1512 allows the processing unit to communicate with remote units via the networks. For example, the communications subsystem 1512 may provide wireless communication via one or more transmitters/transmit antennas and one or more receivers/receive antennas. In an embodiment, the processing unit is coupled to a local-area network or a wide-area network, for data processing and communications with remote devices, such as other processing units, the Internet, remote storage facilities, or the like.

The embodiments described herein are intended to be illustrative of the present compositions and methods and are not intended to limit the scope of the present invention. Various modifications and changes consistent with the description as a whole and which are readily apparent to the person of skill in the art are intended to be included. The appended claims should not be limited by the specific embodiments set forth in the examples, but should be given the broadest interpretation consistent with the description as a whole.

1. A method at a computing device for splatting of objects, the method comprising:
preforming a pre-processing on a scene, the pre-processing comprising:
placing the objects into a Bounding Volume Hierarchy by creating nodes and leaf nodes; and
sorting the objects in each leaf node with respect to a center of the leaf node, thereby creating sorted objects for each leaf node;
traversing the Bounding Volume Hierarchy during rendering, the traversing comprising:
finding an order of the nodes and leaf nodes based on a viewpoint; and
fetching the sorted objects in each leaf node; and
creating a scene representation based on the fetching.

2. The method of claim 1, wherein the objects are Three Dimensional (3D) Gaussians.

3. The method of claim 1, wherein the placing comprises setting a parameter for the maximum number of objects that should be present in each leaf node, wherein, when the maximum number of objects for a first leaf node exceeds the parameter, an additional node is created.

4. The method of claim 1, wherein the Bounding Volume Hierarchy uses a data structure comprising at least one of an octree and a k-dimensional tree.

5. The method of claim 1, wherein the fetching further comprises:
dividing each leaf node into a positive space and a negative space based on the viewpoint;
fetching objects from those most distant from the center of the leaf node to those closest to the center of the leaf node for the objects in the positive space; and
fetching objects from those closest to the center of the leaf node to those most distant from the center of the leaf node for objects in the negative space.

6. The method of claim 1, wherein the rendering further comprises:
prior to the traversing:
computing properties per object; and
projecting each object to a two dimensional space; and
after the traversing:
blending all visible objects based on depth order.

7. The method of claim 1, wherein the sorting comprises:
sorting the objects based on a distance from the mean of the object to the center of the leaf node.

8. The method of claim 7, further comprising choosing a bounding box size for each leaf such that ∥g′∥²∝d, where g′ is a vector from the center of each leaf node to the mean of the object; d is a dot product of a view direction with a g vector; and the g vector is a vector from the view direction to the mean of the object.

9. The method of claim 1, wherein the pre-processing and traversing is further used during training.

10. A computing device comprising:
memory; and
a processor,
wherein the computing device is configured to:
preform a pre-processing on a scene by:
placing the objects into a Bounding Volume Hierarchy by creating nodes and leaf nodes; and
sorting the objects in each leaf node with respect to a center of the leaf node, thereby creating sorted objects for each leaf node;
traverse the Bounding Volume Hierarchy during rendering by:
finding an order of the nodes and leaf nodes based on a viewpoint; and
fetching the sorted objects in each leaf node; and
create a scene representation based on the fetching.

11. The computing device of claim 1, wherein the objects are Three Dimensional (3D) Gaussians.

12. The computing device of claim 10, wherein the placing comprises setting a parameter for the maximum number of objects that should be present in each leaf node, wherein, when the maximum number of objects for a first leaf node exceeds the parameter, an additional node is created.

13. The computing device of claim 10, wherein the Bounding Volume Hierarchy uses a data structure comprising at least one of an octree and a k-dimensional tree.

14. The computing device of claim 1, wherein the computing device is configured to perform the fetching by:
dividing each leaf node into a positive space and a negative space based on the viewpoint;
fetching objects from those most distant from the center of the leaf node to those closest to the center of the leaf node for the objects in the positive space; and
fetching objects from those closest to the center of the leaf node to those most distant from the center of the leaf node for objects in the negative space.

15. The computing device of claim 10, wherein the computing device is further configured to render by:
prior to the traversing:
computing properties per object; and
projecting each object to a two dimensional space; and
after the traversing:
blending all visible objects based on depth order.

16. The computing device of claim 10, wherein the computing device is configured to sorting the objects based on a distance from the mean of the object to the center of the leaf node.

17. The computing device of claim 16, wherein the computing device is further configured to choose a bounding box size for each leaf such that ∥g′∥² ∝d, where g′ is a vector from the center of each leaf node to the mean of the object; d is a dot product of a view direction with a g vector; and the g vector is a vector from the view direction to the mean of the object.

18. The computing device of claim 10, wherein computing device is configured to perform the pre-processing and traversing during training.

19. A non-transitory computer readable medium for storing instruction code, which, when executed by a processor of a computing device, cause the computing device to:
preform a pre-processing on a scene by:
placing the objects into a Bounding Volume Hierarchy by creating nodes and leaf nodes; and
sorting the objects in each leaf node with respect to a center of the leaf node, thereby creating sorted objects for each leaf node;
traverse the Bounding Volume Hierarchy during rendering by:
finding an order of the nodes and leaf nodes based on a viewpoint; and
fetching the sorted objects in each leaf node; and
create a scene representation based on the fetching.

20. The non-transitory computer readable medium of claim 19, wherein the objects are Three Dimensional (3D) Gaussians.
